(19) United States
(12) Patent Application Publication
(10) Pub. No.: US 2009/0267475 A1
(43) Pub. Date: Oct. 29, 2009

(54) HIGH-PRESSURE GAS DISCHARGE LAMP

(75) Inventors: Arnd Ritz, Heinsberg (DE); Jsoephus Christiaan Maria Hendricx, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,702

(22) PCT Filed: May 5, 2006
(86) PCT No.: PCT/IB06/51415

§ 371 Date: Nov. 6, 2007

(30) Foreign Application Priority Data
May 11, 2005 (EP) 05103946.9

(51) Int. Cl. H01J 61/40

(52) U.S. Cl. 313/112

(57) ABSTRACT

The invention relates to a high-pressure gas discharge lamp, which has at least a burner or an inner lamp envelope whose wall mainly consists of a ceramic material, namely a polycrystalline aluminum oxide material (PCA), YbAG- or YAG-material, and at least an interference filter is arranged on at least part of the surface of this wall, wherein this interference filter consists of several layers and in whose layer structure a layer with a higher refractive index alternates with a layer with a lower refractive index, the layer with a lower refractive index mainly consists of Al2O3 and with operation of the lamp the maximum temperature of the wall is more than 1400K.

The invention relates to a high-pressure gas discharge lamp, which has at least a burner or an inner lamp envelope whose wall mainly consists of a ceramic material, namely a polycrystalline aluminum oxide material (PCA), YbAG- and/or YAG-material, and at least an interference filter is arranged on at least part of its surface. This interference filter consists of several layers, wherein in the layer structure a layer with a higher refractive index alternates with a layer with a lower refractive index.

Commercial high-pressure gas discharge lamps (HID—[high intensity discharge]-lamps) and particularly UHP—(ultra high performance) lamps are preferably used for example for projection purposes due to their optical characteristics. Usually, these lamps usually have a burner or an inner lamp envelope, which mainly consists of a quartz material. Among other things, the operating temperature of these lamps is limited by the quartz material used and is maximum approximately 1200 to 1370 K at the hottest spot of the envelope.

The ceramic high-pressure gas discharge lamps, which have at least a burner or an inner lamp envelope, whose walls mainly comprise a ceramic material also rank among the high-pressure gas discharge lamps. Such materials are, for example, a polycrystalline aluminum oxide (PCA [polycrystalline alumina]), yttrium aluminum garnet (YAG) or ytterbium aluminum garnet (YbAG).

The integration of optical layers, for example, of interference filters, on lamp envelopes or burners of ceramic high-pressure gas discharge lamps can essentially simplify the design of optical devices.

Such interference filters regularly have a multi-layer structure. With a multi-layer structure of the interference filter, layers with a higher refractive index alternate with layers with a lower refractive index. The refractive index of the respective layer is determined particularly by the selected material of the layer, wherein at least two, in this regard, different dielectric materials are to be found in the layer structure.

The transmission and reflection properties of the filters are determined by the design of the different layers of the filter, particularly their layer thickness. Basically, the larger the difference between the refractive indices of the individual layers of the filter the better it is to realize a desired spectral target function. With a large difference between the values of the refractive indices of the materials of the layers, often the number of alternating layers and thus the total thickness of the interference filter can be reduced.

If the lamp envelope consists of particularly quartz or the like, often SiO2 is used as a material for the layer with the lower refractive index. With the selection of the material of the layer with the higher refractive index the range of the usual operating temperature of UHP lamps, whose upper range lies approximately around 1000° C., must be considered. In this regard zirconium oxide (ZrO₂) has, for example, sufficient temperature stability. However, zirconium oxide essentially has a considerably higher thermal coefficient of expansion than quartz. Therefore, with the high operating temperatures of high-pressure gas discharge lamps, particularly of UHP lamps, tensions may arise between the layers of the interference filter, which tensions may lead to the crack formation in the filter up to the point of its destruction, or cause undesired increased light scattering respectively.

In addition, there are ceramic high-pressure gas discharge lamps, which have at least a burner or an inner lamp envelope, which mainly consists of a polycrystalline aluminum oxide material (PCA), for example known from U.S. Pat. No. 6,741,033 B2 or mentioned there respectively. The maximum operating temperature of these lamps is regularly more than 1400 K or higher. For example, the high-pressure sodium-vapor lamps like HPS—[high-pressure sodium] Philips lamps and the high-pressure metal halogen vapor lamps, like CDM—[ceramic discharge metal halide] Philips lamps belong to the group of the ceramic high-pressure gas discharge lamps.

Depending on the respective application, the maximum operating temperature of HPS lamps is usually between approximately 1450 and 1600K; of CDM-lamps used for general lighting purposes with high luminous intensity, such as for example, for retail shops, theatres and streets, between approximately 1400 and 1500K and of CDM-automobile lamps, such as, for example for main headlights, between approximately 1650 and 1750K.

For these ceramic high-pressure gas discharge lamps also, whose walls mainly comprise a ceramic material, for example, a polycrystalline aluminum oxide (PCA), there is a need to use the advantages, which result from the integration of optical layers, for example, of interference filters, on lamp envelopes or burners of high-pressure gas discharge lamps. A transfer of the known filter systems from high-pressure gas discharge lamps with lamp envelopes of quartz or the like to lamps with ceramic materials is not possible. The SiO₂ often used as yet as material for the layer with the lower refractive index is not usable with operating temperatures of more than 1400K.

With certain applications, it is also desired that the thermal system of the lamp developed is not disrupted on reaching the operating temperature, particularly to not endanger the operational reliability of the lamp.

This thermal system optimized in commercial lamps often reacts very sensitively to measures that affect or change respectively the temperature field in the discharge vessel. The application of a reflecting layer on the outer surface of the wall often represents such a measure, whereby the operating temperature of the lamp normally increases compared to such a lamp without a coating.

The application of a coating in for example a multi-layer interference filter, in addition regularly leads to a changed thermal radiation of the surface of the wall as against an uncoated surface, so that the lamp can often give off less warmth and, as a result, the operating temperature increases by comparison.

For example, the highest temperature on the inner surface of the discharge vessel should not exceed the maximum permissible wall temperature, in order not to reduce significantly the life span of the lamp.

The object, which forms the basis of the invention, therefore comprises providing a ceramic high-pressure gas discharge lamp of the type specified above or a lighting unit with such a lamp respectively, whose inner lamp envelope or burner respectively has an effective interference filter, which is commensurate with the maximum wall temperature.

The object of the invention is achieved by the characteristic features of claim 1.

This high-pressure gas discharge lamp in accordance with the invention has a burner or an inner lamp envelope whose wall mainly consists of a ceramic material, namely a polycrystalline aluminum oxide-material (PCA), YbAG- or YAG-material. On at least part of the surface of this wall at least an interference filter is arranged, which interference filter consists of a plurality of layers and in its layer structure a layer with a higher refractive index alternates with a layer with a lower refractive index, the layer with a lower refractive index mainly consists of Al₂O₃ and the operating temperature of the lamp is more than 1400K.

The solution in accordance with the invention is based particularly on the results obtained from extensive trials with PCA lamps, that is, trials with most different designs as regards the interference filter. These results particularly comprise the recognition that with ceramic high-pressure gas discharge lamps the selection of the materials of the coating, the design of the individual layers and their arrangement in the layer structure are of essential significance for achieving the desired spectral target function.

In addition, new design possibilities and areas of use are opened by ceramic high-pressure gas discharge lamps with such interference filters.

The pre-selection of the materials of the interference filter as well as the method for the application of the respective layers of the filter takes place in the usual way and is particularly related to the respective application. The selected material should lead, for example, to as little absorption as possible. In addition, these materials should have a sufficient temperature stability, that is, be particularly attuned to the respective maximum operating temperature of the lamp.

The dependent claims contain advantageous further aspects of the invention.

It is preferred that the layer of the interference filter with a higher refractive index consists of a material, preferably predominantly zirconium oxide (ZrO2), which has a higher refractive index than aluminum oxide Al₂O₃. ZrO2 is then particularly preferred since it absorbs less and is temperature-resistant than most other materials in this regard.

Alternatively, it is preferred that the layer of the interference filter with a higher refractive index consists of a material of the group of titanium oxide or tantalum oxide or a mixture of these materials.

Apart from the aforementioned materials and their mixtures, further materials can be used in the context of the invention, which materials can be verified, for example, by corresponding tests on their applicability.

In addition, it is preferred that the lamp is a ceramic high-pressure sodium-vapor lamp, like for example, an HPS lamp, with a maximum operating temperature between approximately 1450K and 1700K.

Alternatively it is preferred that the lamp is a ceramic high-pressure metal halogen vapor lamp, like, for example, a CDM lamp, with a maximum operating temperature between approximately 1450K and 1750K.

Preferred methods for the production of the interference filters are known standard methods of thin-film technology, particularly by means of evaporation, sputtering, chemical gaseous phase separation, laser treatment or dipping.

The object of the invention is further achieved by a lighting unit with at least one lamp as claimed in any one of the claims 1 to 7. Such a lighting unit with at least a high-pressure gas discharge lamp in accordance with the invention can be used for most different applications.

For example is mentioned:

Ceramic high-pressure sodium-vapor lamps as street lighting, wherein in the case of an approximately horizontal installation position (or at an angle of 15° to the horizontal respectively) of the lamp a multi-layer interference filter is arranged on the lower part of the burner. Thus, an improved homogeneity of the illumination of the street is achieved.

For example, further is mentioned:

Ceramic high-pressure metal halogen vapor lamp as a lighting unit in the architecture range, for example, as radiated lighting from above or from below, which are called downlights or uprights. With these lighting units, reflectors and lenses are regularly integrated in the lighting system of the light. In the case of a vertical installation position of the lamp, a multi-layer interference filter is arranged on one or more segments around the lamp axis on the surface of the burner. The arrangement of the burner surface section(s) covered with an interference filter is such that no surfaces covered with interference filters symmetrically to the burner axis are facing each other.

The interference filter is structured in such a way that it reflects back more than 70% of the incident visible light. Thus the reflected light is led by the envelope in the direction of the opposite burner wall, which is uncoated and can emerge there from the burner. This increases the light intensity in this direction, as against the light intensity in this direction with a lamp without an interference filter.

Thus the light distribution of the lamp can be influenced by the geometry of the interference filter. Thereby, the freedom of design of the lamp manufacturer is increased. For example, segments of the normally round reflector can be shadowed by the interference filter, so that these shadowed reflector parts do not have to be implemented any more, without sustaining essential loss of light. As a result, new lamp designs are made possible.

These and other aspects of the invention are apparent from and will be elucidated with reference to the embodiments described hereinafter, though the invention should not be considered to be limited to these.

### IN THE DRAWINGS

FIG. 1 shows the layer structure of a 27-layer interference filter of a ceramic high-pressure gas discharge lamp.

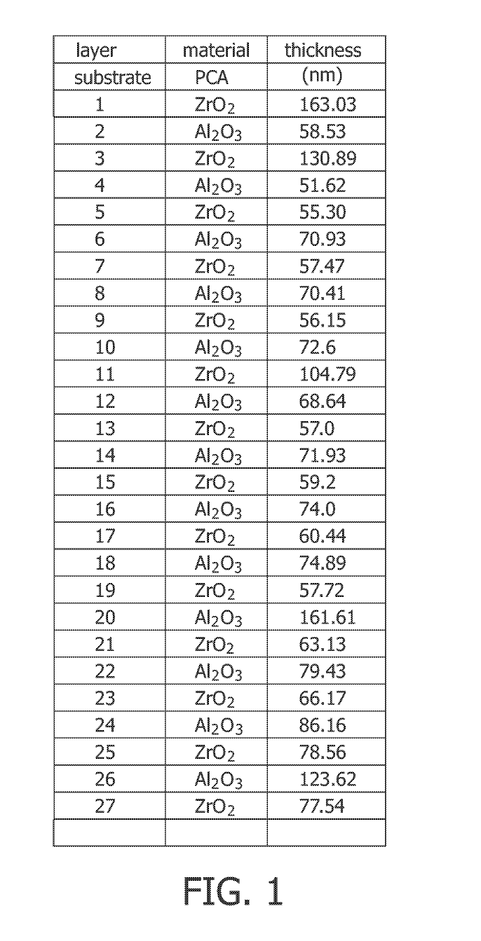

In a table, FIG. 1 shows the layer structure of a 27-layer interference filter, which is arranged on a sub-area of the outer surface of a burner of a ceramic high-pressure gas discharge lamp. The burner known per se, that is, conventional burner particularly with reference to form and structure, mainly consists of a polycrystalline aluminum oxide material (PCA). The outer surface of the tubular base plate of the burner of the high-pressure gas discharge lamp manufactured by extrusion for laboratory tests is polished or smoothed. The design of the interference filters is selected such as to achieve the following spectral target function, namely a partial reflection of more than 40% in the range from 400 Nm to 700 Nm. The interference filter is thus suitable for functioning as a what is called cold mirror.

The two different layers 3.1 and 3.2 of the interference filter 3 are particularly characterized by a differing refractive index, wherein a layer with a low index alternately follows a layer with a higher index. Al₂O₃ with the lower refractive index serves as a material of the layer 3.2; ZrO₂ as a material of the layer 3.1 with the higher refractive index.

The layer-wise application of the interference filter 3 takes place in a production process via a sputtering method known by itself.

This interference filter has a 27-layer structure, wherein the total Al₂O₃ layer thickness is about 1064.5 nm and the total ZrO₂ layer thickness is about 1087.5 nm. Thus, the total thickness of the filter is 2152 nm. This interference filter has the necessary temperature stability in the range of operating temperatures between room temperature and a temperature of approximately 1400K.

In the case of the usage of the lamp in accordance with the invention, for lighting purposes for streets with about horizontal installation position of the lamp the interference filter is arranged in the lower area of the lamp, namely, for example, in an area of about 150° around the lamp axis on the outer surface of a burner of a ceramic high-pressure gas discharge lamp. Thus, in the operating state of the lamp, which has a lighting unit that has at least one reflector, the interference filter points to the street. Thus, part of the emitted light is reflected on the interference filter and reflector, before it illuminates the street. The filter brings about that the direct radiation to the street in the waveband from 400 nm to 700 nm is reduced by more than 40% compared to a comparable lamp without such a filter.

Thus, the glare of the lamp is significantly reduced and the homogeneity of illuminating the street, within the core area of the illuminated area of the street, is improved. Reflected light is distributed better over the street than light, which would reach the street directly.

1. A high-pressure gas discharge lamp, which has at least a burner or an inner lamp envelope (1) whose wall mainly consists of ceramic material, namely a polycrystalline aluminum oxide material (PCA), YbAG- or YAG-material, and at least an interference filter (3) is arranged on at least part of the surface of this wall, wherein this interference filter (3) consists of a plurality of layers and in its layer structure a layer (3.1) with a higher refractive index alternates with a layer (3.2) with a lower refractive index, the layer (3.2) with a lower refractive index mainly consists of Al₂O₃ and with operation of the lamp the maximum temperature of the wall is more than 1400K.

2. A lamp as claimed in claim 1, characterized in that the layer (3.1) with a higher refractive index of the interference filter (3) consists of a material, preferably predominantly zirconium oxide (ZrO₂), which has a higher refractive index than Al₂O₃.

3. A lamp as claimed in claim 1, characterized in that the layer (3.1) with a higher refractive index consists of a material of the group of titanium oxide or tantalum oxide or a mixture of these materials.

4. A lamp as claimed in claim 1, characterized in that the lamp is a ceramic high-pressure sodium-vapor lamp with a maximum operating temperature between approximately 1450K and 1700K.

5. A lamp as claimed in claim 4, characterized in that the lamp is a ceramic high-pressure sodium-vapor lamp for street lighting.

6. A lamp as claimed in claim 1, characterized in that the lamp is a ceramic high-pressure metal halogen vapor lamp with a maximum operating temperature between approximately 1450K and 1750K.

7. A lamp as claimed in claim 6, characterized in that the lamp is a ceramic high-pressure metal halogen-vapor lamp for architectural lighting.

8. A lighting unit with at least a lamp as claimed in claim 1.
